(19) United States
(12) Patent Application Publication
(10) Pub. No.: US 2020/0384748 A1
(43) Pub. Date: Dec. 10, 2020

(54) Recyclable polyethylene film construction

(71) Applicant: Preco, Inc., Somerset, WI (US)

(72) Inventors: Matt Lackner, Prescott, WI (US); Joshua Butz, River Falls, WI (US); Mark Daun, Hudson, WI (US)

(21) Appl. No.: 16/890,609

(22) Filed: Jun. 2, 2020

Related U.S. Application Data
(60) Provisional application No. 62/857,648, filed on Jun. 5, 2019.

(51) Int. Cl. B32B 27/32; B32B 27/08; B32B 27/30

(52) U.S. Cl. CPC B32B 27/32; B32B 27/08; B32B 27/306; B32B 2323/043; B32B 2439/70; B32B 2329/04; B32B 2331/04; B32B 2310/0843; B32B 2323/046

(57) ABSTRACT

An additive for high density, standard density, or low density polyethylene films, the additive comprising ethylene vinyl acetate wherein the ethylene vinyl acetate is added in an amount sufficient to increase the laser absorption of the polyethylene film and results in a film for laminating to a sealant layer to produce packaging, the packaging being recyclable and openable via tearing without tools such as a scissor or knife. The polyethylene with additive layer can be formed by co-extrusion of the polyethylene and ethylene vinyl acetate to form a filmor by blending of the polyethylene and ethylene vinyl acetate components for forming the film.

### CROSS-REFERENCE TO RELATED APPLICATION

The present application claims priority to and the benefit of U.S. provisional application Ser. No. 62/857,648, filed on Jun. 5, 2019, the contents of which are hereby incorporated in their entirety.

### BACKGROUND

Flexible packaging, including food packaging, typically consists of an outer printed polyester (PET) layer laminated to an inner polyethylene (PE) sealant layer. This results in strong packaging having good barrier properties for protecting the contents inside the packaging. Due to the high laser absorption of the PET layer, all common industrial packaging laser systems can easily score this lamination to create an easy to tear open package. However, the lamination of two distinct polymer types results in non-recyclable packages as once these polymers are laminated, they cannot be separated. These single use packages end up in land-fills.

One solution has been to develop packaging consisting of a high-density polyethylene (HDPE) outer layer laminated to a polyethylene (PE) sealant layer that is co-extruded with ethylene vinyl alcohol (EVOH) to enhance the barrier properties of the packaging. EVOH is not considered a dissimilar polymer with respect to HDPE and PE and thus, this packaging is fully recyclable. Unfortunately, the resulting packaging is virtually impossible to open without a knife or scissors. Furthermore, due to the poor laser absorption of the outer HDPE layer and high absorption of the EVOH layer sandwiched in the center of the lamination, attempts at laser scoring these packages destroys the barrier properties of the packaging and makes the packages even more difficult to open.

### SUMMARY

An aspect of the present disclosure relates to a recyclable polyethylene construction. The construction may be a multi-layer film construction comprising a high density polyethylene, or standard density polyethylene, and ethylene vinyl acetate layer, and a EVOH/polyethylene sealant layer. The film is recyclable and can be used in various types of packaging including food packaging.

Another aspect of the present disclosure relates to a method of forming a recyclable polyethylene film, the method comprising co-extruding a layer comprising high density polyethylene, standard density polyethylene, or low density polyethylene and ethylene vinyl acetate as components and laminating a polyethylene sealant layer to the co-extruded polyethylene and ethylene vinyl acetate layer to provide a higher laser absorbing recyclable film.

Yet another aspect of the present disclosure relates to a method of forming a recyclable polyethylene film, the method comprising blending high density polyethylene, standard density polyethylene, or low density polyethylene and ethylene vinyl acetate and forming a layer of film from said blend. This blend may be provided as an extruded or cast film. Additionally, or alternatively, the blend is provided as a polymer resin component or components. The method further may comprise laminating a polyethylene sealant layer to the blended film layer to provide a higher laser absorbing recyclable multi-layer film.

In another embodiment, a method of increasing laser absorption of a polyethylene film comprises providing ethylene vinyl acetate as an additive, or coating to a high density, standard density, or low density polyethylene layer.

In another aspect of the present disclosure, the multi-layer film comprises a first layer that consists essentially of two layers, one of the two layers being high density polyethylene, standard density, or low density and the other of the two layers being ethylene vinyl acetate or wherein the first layer is a blend or lamination of polyethylene and ethylene vinyl acetate.

In yet another embodiment, the present disclosure relates to an additive for polyethylene films. The additive is ethylene vinyl acetate. The additive may be co-extruded with the polyethylene to form a film or may be blended with the polyethylene prior to forming the film, or added as a coating to the film. The film may then be laminated to a polyethylene sealant film for forming a recyclable, easy-open (or tear open), packaging.

Another aspect of the present disclosure relates to a blended resin compositionally comprising ethylene vinyl acetate and polyethylene. In one or more embodiments, the blended resin comprises only ethylene vinyl acetate and polyethylene in any ratio of components including but not limited to 1:1, 2:1, 3:1, 4:1 or 1:2, 1:3, 1:4.

The blended resin can be incorporated into a multi-layer recyclable polyethylene film.

In one or more aspects and embodiments, the blended resin or additive of the present disclosure does not include ethylene vinyl alcohol.

In one or more aspects and embodiments, a film may be formed without ethylene vinyl alcohol.

### DETAILED DESCRIPTION

An additive for use in a standard polyethylene (PE) film that increases the laser absorption of the film is disclosed herein. The film may be used in packaging of various types and remains fully recyclable while easy to open (e.g., “tear-able”). For example, when the additive is introduced to the PE film, the resulting film can be used to construct packing such as food packaging without destroying the barrier properties of the packaging, and without compromising recyclability of the packaging as described herein.

The additive is an ethylene vinyl acetate (EVA) based additive. For example, EVA may be added to a high-density polyethylene (HDPE) film or resin to produce a recyclable film having increased laser absorption that can be used in various types of packaging, including food packaging. The EVA may be added to the HDPE via blending. The EVA may be added to the HDPE by co-extrusion or the EVA may be added to the HDPE via coating. An HDPE-EVA film may then be laminated with a polyethylene (PE)/EVOH layer to retain the barrier properties of resulting packaging after laser scoring. It has been found that EVA greatly increases the laser absorption of the HDPE layer. The result is an easy to open, laser scored package with no damage to the EVOH barrier layer. Similar to EVOH, EVA is not considered a dissimilar polymer with respect to HDPE, LDPE and PE and therefore this package structure is fully recyclable. Further, the packaging is easy to open without unnecessarily reducing the thickness of the film used in the packaging.

There are numerous additional applications for the EVA enhanced polyethylene with respect to laser absorption. The composition can be utilized in laser perforated film for breathability, laser vented film for microwave venting packages, and laser scored film for tear-open packaging, among other types of packaging.

An additional benefit of the PE-EVA film is an enhancement of the laser energy absorption of the resulting film. The EVA additive increases the laser absorption of the HDPE, LDPE, or PE film and thus scoring, perforating, venting or cutting the film with common industrial packaging laser systems becomes more efficient and less expensive. The time and/or laser energy needed to laser process the film for end-use packaging can be reduced.

In one embodiment, packaging comprises a high-density polyethylene (HDPE) outer layer laminated to a polyethylene (PE)/EVOH sealant layer having an EVA layer there between. The EVA layer may be co-extruded with the HDPE, or the HDPE may be doped with EVA via blending the EVA with the HDPE when producing the HDPE film.

For example, when multiple plastics are combined via co-extrusion, the result can yield properties distinct from those of a single material. This is the case with the co-extrusion of HDPE and EVA starting materials. In co-extruding, unlike ordinary plastic mixing, each individual plastic retains its original properties, but is combined into a compound-material part. If mixed prior to extrusion, the characteristics of the individual materials may be altered, and the end result is a homogeneous product. In one embodiment, the HDPE, LDPE, or PE and EVA starting materials may be mixed prior to co-extrusion.

In one embodiment the HDPE, LDPE, or PE and EVA may be blended. Blending is an efficient, thorough and automated way to combine the HDPE, LDPE, or PE and EVA, which are provided in pre-determined proportions and mixed together in preparation for the production of plastic parts, films, or products. The HDPE, LDPE, or PE and EVA may be metered into the blend by quantity (volumetric blending) or by weight (gravimetric blending).

In one embodiment, the EVA is ethylene vinyl acetate having a weight percent of vinyl acetate in the range of about 0.1% to about 40%, or greater. For example, the EVA may have a low proportion of vinyl acetate in the range of about 0.1% to about 4% vinyl acetate and more specifically less than about 4% vinyl acetate. It is contemplated that In another example, the EVA may have a moderate proportion of vinyl acetate, in the range of about 4% to 30% vinyl acetate and in one embodiment may comprise about 11% vinyl acetate similar to hot melt adhesives. In another example, the EVA may have a high proportion of vinyl acetate, greater than about 40%.

As referred to throughout this disclosure, laser processing, for example, includes cutting, scoring, welding and/or perforating the material. The laser beam energy and laser processing system optics are selected to affect the material in a target area (e.g., an area on the material at or near the laser beam focal point) to a depth equal to, or less than the thickness of the material depending on the ultimate use of the material.

In further detail, a laser processing system referred to herein is a system for processing (e.g., perforating, scoring, welding, or cutting) a material through the use of laser beam technology. Lasers provide a very efficient method of cutting, scoring, welding, perforating or otherwise preparing selected materials for various end uses over the old mechanical systems for cutting or scoring materials. Lasers cut, score, weld, or perforate the material through the use of a collimated amplified beam of light that terminates in a focal point. It is at or near the focal point of the beam that processing typically occurs. Intense energy at the focal point processes the material in what can be described as essentially a vaporizing, burning, melting, or ablating process. The ability of laser technology to cut, score, weld or perforate a material depends, at least in part, on how well the material reacts to the wavelength of the laser beam. What is meant by “reacts” is the ability of the material to absorb light or heat at the selected wavelength.

An assembly for laser processing the material as described herein comprises a laser source in communication with optics for directing the beam or multiple beams to the material for processing. The material for processing may also be referred to herein after as a “substrate.” The substrate may be stationary during laser processing, while the laser beam moves to produce one or more holes or perforations etc. in the substrate. Additionally or alternatively, the substrate may be a moving web such that the substrate moves through the laser assembly during laser processing. This allows a web of substrate to be processed continuously while passing below the laser beam concurrently during processing to produce a plurality of holes, perforations or cuts or scores on the substrate.

A focal point(s) of the laser beam(s) is/are directed to a surface of the substrate using a process referred to as “scanning”, which requires controlling and directing the laser beam(s) for precision perforation (or scoring) along a selected pattern. A controller sends commands to the laser processing assembly to direct and pulse the laser beam(s) precisely as the substrate is positioned for processing (whether the substrate is stationary or moving) to perforate or otherwise process the substrate according to the selected pattern. The pattern may comprise rows and/or columns of aligned perforations, random patterns of perforations, or cut paths. The laser beam(s) may be pulsed when processing the substrate to produce one or more holes or perforations.

The laser assembly may comprise, for example, a CO laser, a CO₂ laser or other lasers and/or laser wavelengths (e.g., UV wavelength) for processing the materials described herein. The laser system and settings are selected based on the construction of the material being processed. For example, a laser wavelength is selected based on its ability to ablate the selected material composition, the material thickness, and the hole diameter. A CO laser or a CO₂ laser has a wavelength particularly suitable for perforating, cutting or scoring the film described herein.

The films comprising an HDPE, LDPE, or PE and EVA layer, regardless of whether the HDPE, LDPE, or PE and EVA are blended and/or co-extruded, or coated, may be laser processed to score, perforate and/or cut the film for use in packaging such as food packaging. The films comprising HDPE, LDPE, or PE and EVA may be laminated to a PE/EVOH barrier layer as described above and the multi-layer construction laser scored, perforated and/or cut to provide easy-open, fully recyclable packaging.

A blended resin comprising only ethylene vinyl acetate (EVA) and polyethylene may also be provided. This resin could be provided in various forms for uses such as forming a film. The blended resin of EVA and polyethylene may form a resin in any ratio of the components including but not limited to about a 1:1, about a 2:1, about a 3:1, about a 4:1 or about a 5:1 ratio or conversely about a 1:2, about a 1:3, about a 1:4 or about a 1:5 ratio.

Although the present disclosure has been described with reference to preferred embodiments, workers skilled in the art will recognize that changes may be made in form and detail without departing from the spirit and scope of the disclosure.

1. A recyclable polyethylene multi-layer film wherein a first layer comprises high density polyethylene, standard density polyethylene, or low density polyethylene and ethylene vinyl acetate and a second layer comprises polyethylene/EVOH.

2. The multi-layer film of claim 1 where the film is recyclable.

3. The multi-layer film of claim 1 wherein the film is used in packaging such as food packaging.

4. The multi-layer film of claim 1, wherein the first layer comprises only high density polyethylene and ethylene vinyl acetate, standard density polyethylene and ethylene vinyl acetate, or low density polyethylene and ethylene vinyl acetate.

5. The multi-layer film of claim 1, wherein the first layer consists essentially of two layers, one of the two layers being either high density polyethylene, standard density polyethylene, or low density polyethylene and the other of the two layers being ethylene vinyl acetate or wherein the first layer is a blend of the polyethylene and ethylene vinyl acetate.

6. A method of forming a multi-layer recyclable polyethylene film, the method comprising:
blending a first component, polyethylene and a second component, ethylene vinyl acetate;
forming a layer of film from said blend; and
laminating a polyethylene sealant layer to the blended film or laminating a polyethylene/ethylene vinyl alcohol (EVOH) layer to provide a barrier layer to the multi-layer recyclable film.

7. The method of claim 6 wherein blending the polyethylene and ethylene vinyl acetate to form the film comprises co-extruding the polyethylene and the ethylene vinyl acetate to form the film.

8. The method of claim 7 and further comprising laminating the polyethylene/EVOH sealant layer to the co-extruded polyethylene and ethylene vinyl acetate layer to provide a barrier layer to the film.

9. The method of claim 6, and laser processing the film to score, perforate, weld or cut the film.

10. A method of increasing laser absorption of a polyethylene film, the method comprising providing ethylene vinyl acetate as an additive or a coating to high density polyethylene, standard density polyethylene, or low density polyethylene and laser processing a film formed therefrom to score, perforate, weld, cut, or otherwise laser process the film.

11. The method of claim 10, wherein the film is formed via co-extrusion of the polyethylene and ethylene vinyl acetate.

12. The method of claim 10, wherein the film is formed via blending of the polyethylene and ethylene vinyl acetate.

13. The method of claim 10 wherein the additive comprising ethylene vinyl acetate is added in an amount sufficient to increase the laser absorption of the polyethylene film and results in a film for laminating to a sealant layer to produce packaging, the packaging being recyclable and openable via tearing without tools such as a scissor or knife.

14. The additive of claim 13, wherein the additive is added to the polyethylene via co-extrusion or blending of the components for forming a film.

15. A blended resin compositionally comprising ethylene vinyl acetate and polyethylene.

16. The blended resin of claim 15 incorporated into a multi-layer recyclable polyethylene film.
